(19) United States
(12) Patent Application Publication
(10) Pub. No.: US 2016/0217523 A1
(43) Pub. Date: Jul. 28, 2016

(54) DISCOVERY METHOD FOR BUYERS, SELLERS OF REAL ESTATE

(71) Applicant: Redfin Corporation, Seattle, WA (US)

(72) Inventors: Paul Goodrich, Seattle, WA (US); Brian D. Marsh, Seattle, WA (US); Bryan J. Selner, Seattle, WA (US)

(21) Appl. No.: 15/089,790

(22) Filed: Apr. 4, 2016

Related U.S. Application Data
(63) Continuation of application No. 13/760,856, filed on Feb. 6, 2013, now abandoned.
Application No. 13/760,856 is a continuation of application No. 11/508,748, filed on Aug. 22, 2006.
(60) Provisional application No. 60/710,500, filed on Aug. 22, 2005.

(51) Int. Cl. G06Q 30/06

(52) U.S. Cl. CPC G06Q 30/0635; G06Q 30/0641; G06Q 50/16

(57) ABSTRACT

Sellers can, anonymously to buyers if they choose, expose to potential buyers a property that is or may be for sale, with or without a sales price or listing agreement, with as little or as much description of their property as the sellers wish to provide. Potential buyers can identify the location and/or types of properties that they would be interested in purchasing, with as little or as much specificity as they wish, and, at their option, provide information about themselves, such as their financial ability to complete a purchase, to the extent they wish. The system allows sellers to gauge demand for their properties and, if desired, initiate contact with potential buyers who have expressed an interest in purchasing those types of properties. Similarly, the system allows buyers to identify properties that match their interests and, if desired, initiate contact with potential sellers.

### PRIORITY CLAIM

This patent application is a continuation of and claims the benefit of U.S. application Ser. No. 13/760,856, filed Feb. 6, 2013 which is a continuation of U.S. application Ser. No. 11/508,748, filed Aug. 22, 2006, which claims the benefit of U.S. Provisional Application No. 60/710,500, filed Aug. 22, 2005. All of the foregoing applications are incorporated herein by reference.

### BACKGROUND OF THE INVENTION

The technical field generally relates to software and, more particularly, to the use of software and hardware for facilitating discovery of sellers and buyers of real estate.

Traditionally, a real estate property becomes known in the marketplace at a point when it is listed. In many cases, the seller enters into a listing agreement with a broker (in the idiom of real estate, a “listing” is that which includes, among other things, a price for the real estate property and the commission arrangement with the listing real estate agent). In the vast majority of cases, these listings are then entered into a database under the auspices of one or more of the multiple listing services (MLS). The agent representing buyers can then search these listings to find properties that are for sale. Forced by agreement, many pieces of information in the multiple listing services are kept from both buyers and sellers, causing inefficiencies in discovery by one another.

This summary is provided to introduce a selection of concepts in a simplified form that are further described below in the Detailed Description. This summary is not intended to identify key features of the claimed subject matter, nor is it intended to be used as an aid in determining the scope of the claimed subject matter. A computer system and computer-implemented methods for allowing discovery of buyers, sellers of real estate is provided.

In accordance with this invention, a method form of the invention includes a computer-implemented method that comprises creating a biographical profile by buyers. The method further comprises finding homes or blocks of homes that are of interest to buyers. The method yet further comprises sending solicitations to owners to discover purchase interest in their properties.

In accordance with further aspects of this invention, a method form of the invention includes a computer-implemented method that comprises assessing a market based on query activity by buyers including saved searches and specified list of favorite properties. The method further comprises sending solicitations to buyers to inform them of the availability of properties for purchase.

In accordance with this invention, a system form of the invention includes a computer system that comprises a real estate owner database for storing property features of real estate owners. The computer system further comprises a real estate buyer database for storing desired features of real estate buyers. The desired features include location. The computer system yet further comprises a discovery engine for matching the property features of a real estate owner and the desired features of real estate buyers. The property features include location. The computer system presents to the real estate owner a ranking of the real estate buyers based on criteria selected by the real estate owner or by the computer system.

In accordance with further aspects of this invention, a method form of the invention includes a computer-implemented method, which comprises scoring buyers' desired features and a seller's property features to produce scores. The method further comprises revealing anonymously to buyers a real estate property of a seller without a price. The method yet further comprises informing the seller of a number of buyers whose scores exceed a threshold.

In accordance with further aspects of this invention, another method form of the invention includes a computer-implemented method, which comprises extracting intentions of buyers of real estate explicitly from specified parameters or implicitly from a search query. The method further comprises displaying information about a piece of property on a Web page, the Web page showing intention statistics regarding the piece of property. The method yet further comprises gauging economic demand for the piece of property by viewing the Web page and entering into a transaction by a seller of the piece of property.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrating an exemplary system that allows sellers to discover buyers of real estate and buyers to discover sellers of real estate;

FIG. 2 is a pictorial diagram illustrating an exemplary user interface that presents real estate search results;

FIGS. 3A-3J are process diagrams illustrating an exemplary method for matching real estate buyers and sellers; and

FIGS. 4A-4H are process diagrams illustrating another exemplary method for real estate buyers and sellers to discover one another.

### DETAILED DESCRIPTION

Various embodiments of the present invention provide a means by which sellers can, anonymously to buyers, reveal a real estate property that is potentially for sale, with or without a sales price or listing agreement, with as little or as much description of the property as the seller wishes to provide. Similarly, potential buyers can identify the types of properties (or even specific properties) that they would be interested in purchasing, with as little or as much specificity as they wish, and at their option, provide information about themselves, such as their financial ability to complete the purchase to the extent they wish. In all embodiments, properties or types of properties may be found using location-based search. One suitable location-based search includes the use of maps in combination with satellite images, which are able to zoom, to allow a user to specify a geographic area of interest or to pinpoint a specific property of interest. Other suitable location-base searches may be used, such as textual queries.

In addition, one embodiment of the present invention would allow buyers to rank the order of importance of the features of the property that they seek, by location, size, view, and so on. Other embodiments of the present invention extract intentions from buyers implicitly through their search queries for property or explicitly through property parameters that buyers specify. The word “intention” means interest in purchasing a piece of property. These intentions are processed by various embodiments of the present invention to form intention statistics. Owners of properties can gauge economic demands for their properties using these intention statistics and decide whether to contact potential buyers through various embodiments of the present invention to proceed to a potential sale of their properties.

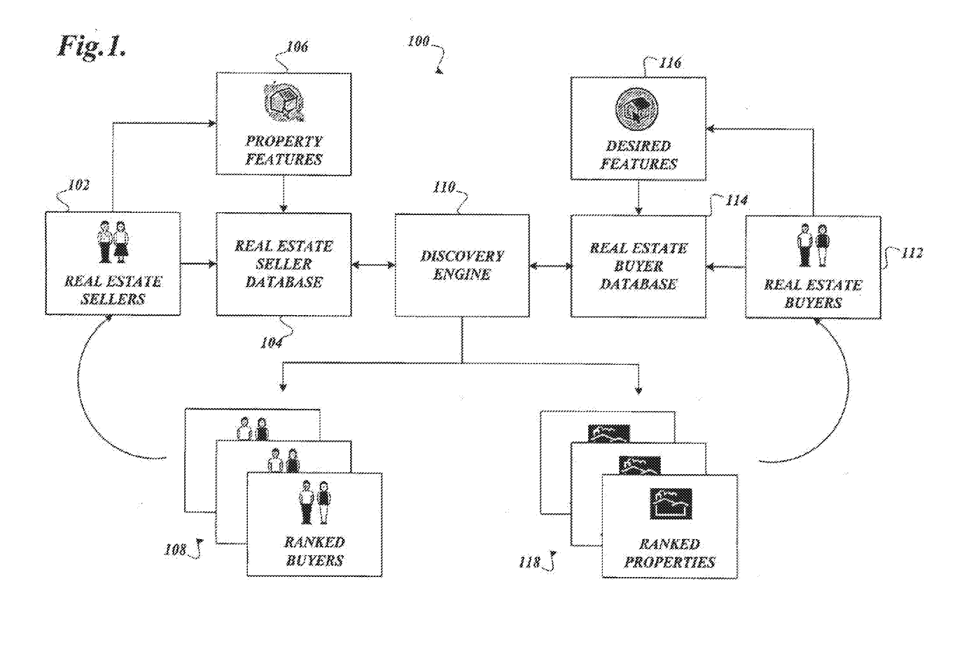

In various embodiments of the present invention, when a real estate seller 102 enters his property into a real estate seller database 104, a discovery engine 110 of a system 100 immediately matches property features 106 specified by the real estate seller 102 with desired features 116 of real estate buyers 112, and at that point (or shortly thereafter), the real estate seller 102 is informed of how many ranked buyers 108 there are for whom there is a substantial match, and in some circumstances, how those ranked buyers 108 (ranked buyers 108 may be a subset of the real estate buyers 112) may be ranked by their qualifications (e.g., “there are six buyers interested in the house you own who have prequalified for financing”). See FIG. 1. Following this initial match, in which both the identity of the real estate seller 102 and ranked buyers 108 may remain unknown to each other, there may follow a series of mutual exchanges of further information, including the willingness of ranked buyers 108 to enter a bid for the property, the willingness to receive pictures of the home, and so on. At some point in this process, the real estate seller 102 would enter into an agreement (e.g., a commission agreement, or subscription agreement, among other things) with an entity, such as the entity that operates the system 100, and the transaction would proceed to completion using a suitable sales process. One suitable sales process includes the traditional process, comprising entering pieces of information connected with the property into the MLS database in those instances where the entity is a member of the MLS. Another suitable sales process may include electronic transactions provided by the system 100 without any involvement by the MLS. In the embodiment where the MLS is not involved, buyers would, through the system 100, notify an owner of a piece of property of the possibility of a transaction. In other words, the system 100, allows the buyers to communicate with the owner via a suitable means, such as a letter, an e-mail, a facsimile communication, and so on, to solicit the owner to purchase the piece of property. To avoid abuse of the solicitation process, the system 100 may charge a buyer for each solicitation a suitable monetary amount or to limit the number of solicitations a buyer may make.

In other embodiments, the system 100 may include a feature that allows the real estate seller 102 to gauge the demand for his property, based on the number of potential buyers 112 who have expressed an interest in a property with the property features 106 described by the real estate seller 102 and those desired features 116 specified by buyers, such as a given price range and so on. In these embodiments, the real estate buyers 112 access the system 100, off-line or on-line through the Internet, to specify the desired features 116 for one or more pieces of property. The real estate buyer database 114 extracts intentions from the real estate buyers 112 using the provided desired features 116 and calculates intention statistics. These intention statistics are shown on a Web page that illustrates the property of the real estate seller 102. These intention statistics allow the real estate seller 102 to gauge the economic demand for his property. When the real estate buyers 112 have specified the desired features 116, the system 100 provides ranked properties 118 to the real estate buyers 112 for their additional research. Another feature of the system 100 to allow the real estate seller 102 to gauge the demand for his property is through the use of an estimate of the fair market value of his property. Through an automated process, the subject property of the real estate seller 102 is compared with recent sales, pending sales, and/or current listings, with the assessed value of recent sales relative to the selling price (or asking price of current listings) and with other information gathered from relevant electronic sources of information. For example, a potential seller, such as the real estate seller 102, may, through various embodiments of the present invention, receive a report, electronically or otherwise, that shows that there are a number of potential buyers 112 for a property that substantially shares the property features 106 specified by the real estate seller 102 in the system 100, of which a subset of the ranked buyers 108 (such as 15) have expressed a willingness to purchase the property with substantially those specified features 116 at a price in excess of a first amount of money (such as $300,000); another subset of buyers (such as 25) between a second amount of money (such as $250,000) and the first amount of money (such as $300,000); and the rest below the second amount of money (such as $250,000).

Various embodiments of this invention have applicability to both the unique matching of properties potentially for sale as well as the type of searching of MLS listings that is common today. The problem, as has been the problem for broader searches in general, is that too often the search generates too many results, requiring a time consuming and tedious task of sorting through the results or the laborious effort to rerun searches for desired properties. Various embodiments of this invention mitigate that problem by allowing buyers to tailor the search results according to features specified and weighted in advance. For example, while there are many features of a property that might be important to the buyer, they are unlikely to have equal weight. By allowing a buyer to specify weights of different features, the buyer can assign relative levels of importance to various property features, so that the search/match results are presented in a more valuable manner. Examples of features that would be ranked include location; number of bedrooms; number of baths; mountain view; city view; water view; lot size; fenced-in yard; attached garage; age; style; waterfront; cul-de-sac; fireplace; modern kitchen; home condition; media room; loft; townhouse; flat; proximity to a location; near a grocery store; near a hotel; amenities, such as limousine service, maid service, butler service, concierge; high-rise; condominium; single family home; commercial class A building; and so on.

For each or some of these features, the prospective buyer would specify what he is interested in (e.g., four bedrooms, media room, rambler, and so on) and then rank the importance of the attribute on a scale, such as from 1-100, where 100 is something that is critical and the buyer does not want to see any listings if that feature is not present. A potential property is scored against the features specified and the results are presented to the buyer as the buyer wishes. For example, if there were 20 features identified by the buyer and the combined score for all those attributes was 1,000 (i.e., a score average of 50 for each feature), the buyer may specify that he only wants to see listings where the aggregate score is at least 700, and a score of 100 on three of the critical features. These properties could also be displayed graphically, showing how the property ranks for each of the attributes, relative to the targeted score.

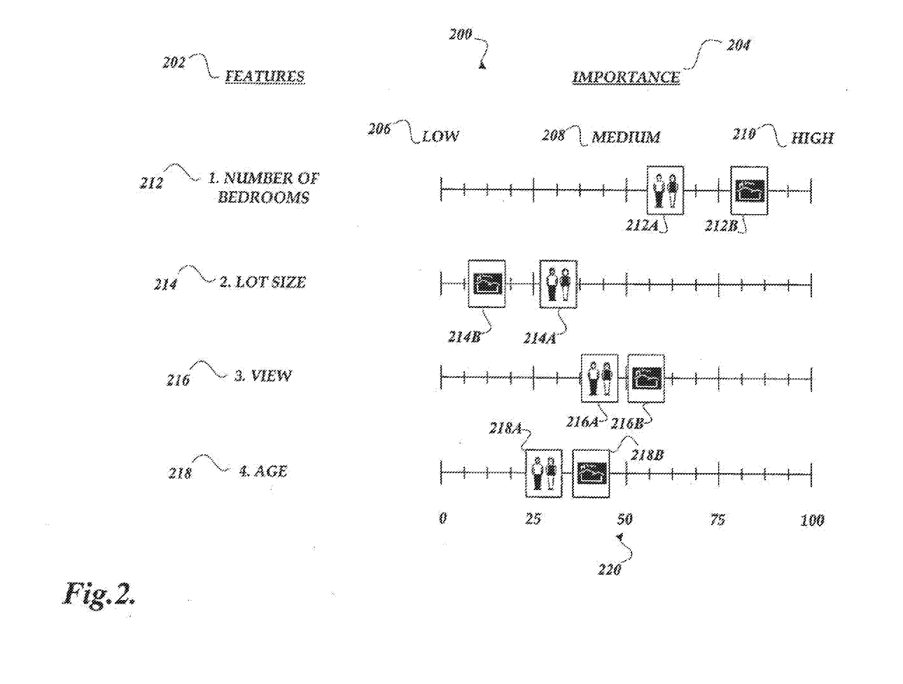

FIG. 2 illustrates an exemplary user interface 200 to present search results for a specific property. A buyer icon 212A-218A graphically showing a man-woman couple indicates a buyer and the position of the buyer icon 212A-218A indicates the level of importance for a particular property feature desired by a buyer. A property icon 212B-218B graphically showing a house indicates a matched property and the position of the property icon 212B-218B indicates the score for a particular feature of the matched property. The user interface 200 allows a buyer to immediately see where the matched property meets, exceeds, or falls short of the buyer's desired property features. An alternative user interface includes showing the score for a substantially matched property. For example, if an average score is 859 for a substantially matched property, a property with a score of 852 may be considered to be fairly close to the average score as specified by the buyer. The threshold by which properties are considered substantially matched can be suitably set by a buyer.

More specifically, the user 200 includes a textual element 202 “features” that marks a column of numbered features desired by a buyer in a piece of property. Another textual element 204 “importance” indicates a column of graphs and the relative positions of icons on these graphs indicate the level of importance for a particular feature and the position of the score for a corresponding feature of a matched property. Textual elements 206 “low,” 208 “medium,” and 210 “high” visually and textually indicate the general locations of importance for various property features and whether a matched property meets, exceeds, or falls short of the buyer's desired property features. Textual element 212 “1. Number of bedrooms” describes a graph to the right in which the icon 212B exceeds a feature threshold set by the buyer as indicated by the icon 212A. Textual element 214 “2. Lot size” describes the graph to the right in which the icon 214B indicates that the matched property falls short of the feature threshold set forth by the buyer at the icon 214A. The textual element 216 “3. View” describes a graph to the right in which a feature threshold set by the icon 216A is exceeded by the property icon 216B. Textual element 218 “4. Age” describes the graph to the right in which the property icon 218B is in a position exceeding the feature threshold set by the buyer at the icon 218A. A set of numbers 220 “0, 25, 50, 75, 100” located at major tick marks of various graphs allow a buyer to quickly visualize the relative numerical scores of various thresholds and the matched property.

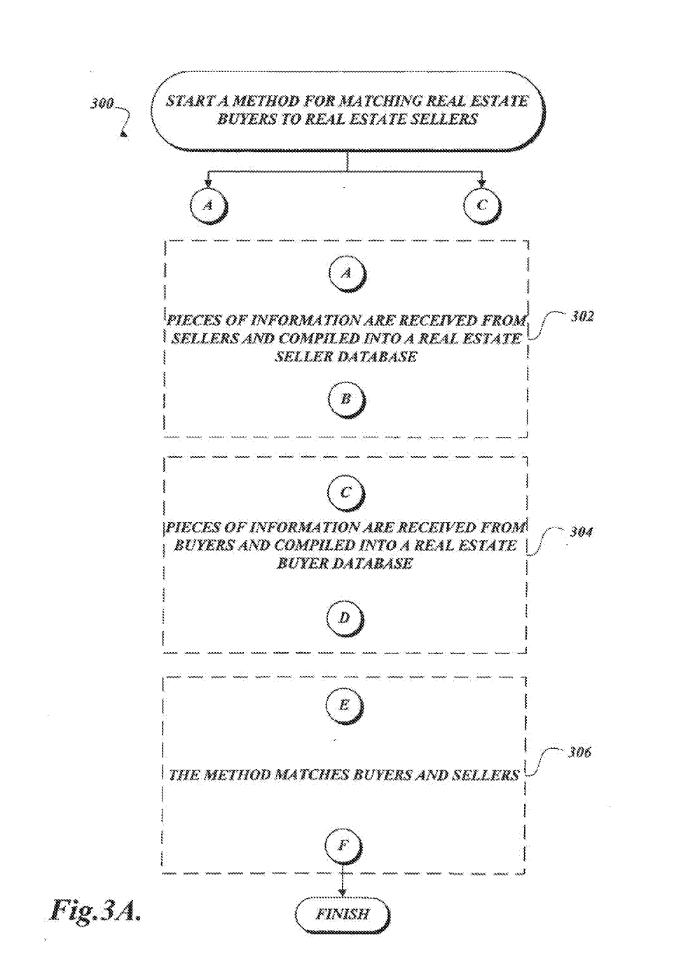

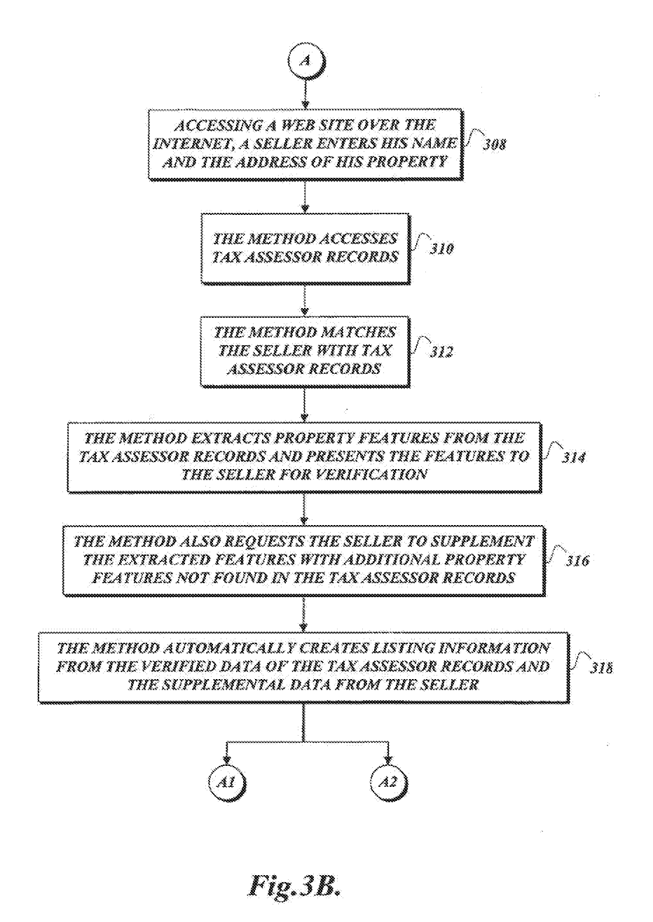

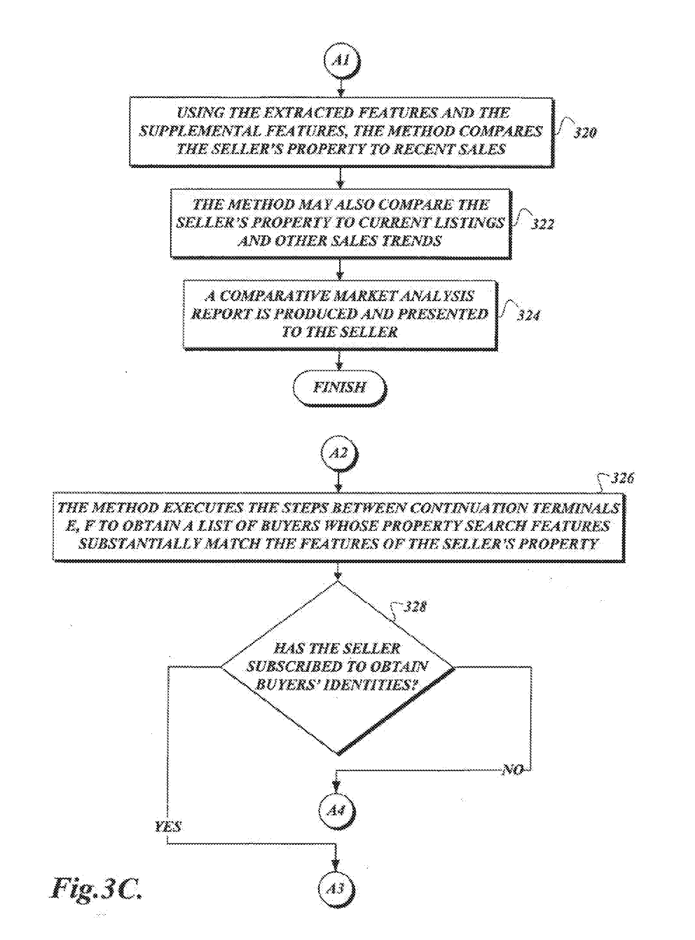

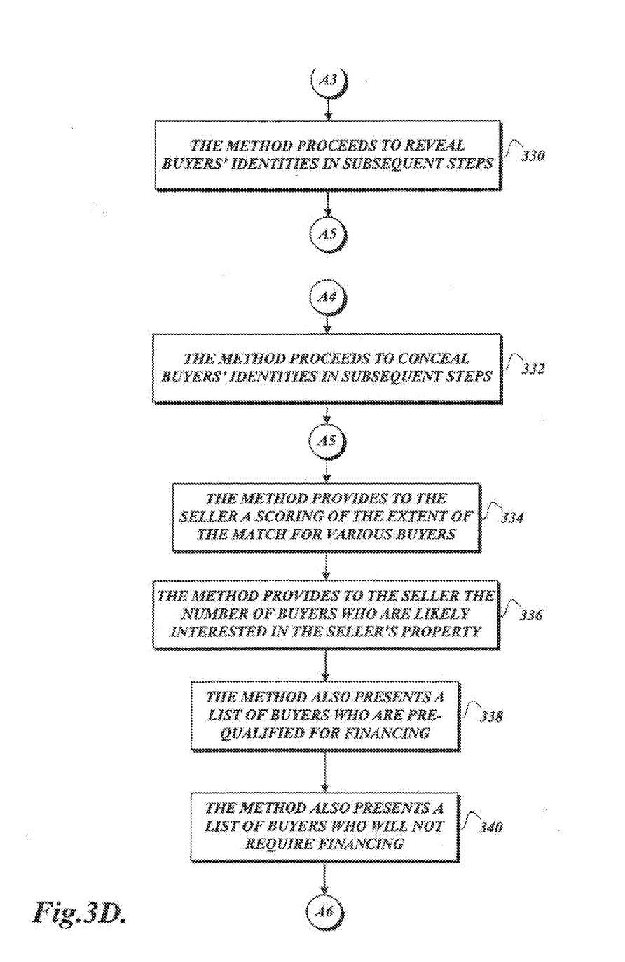

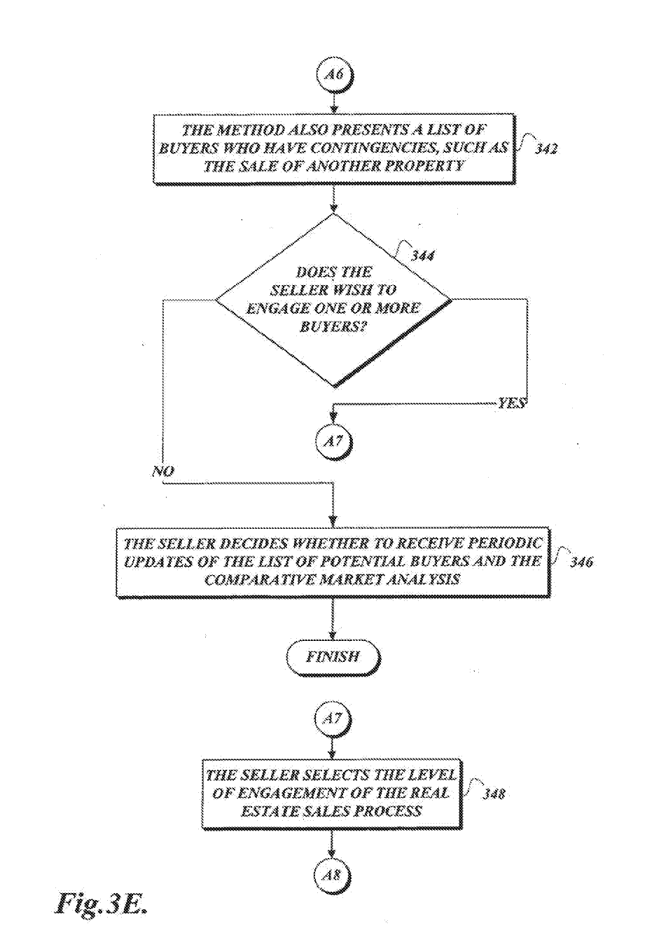

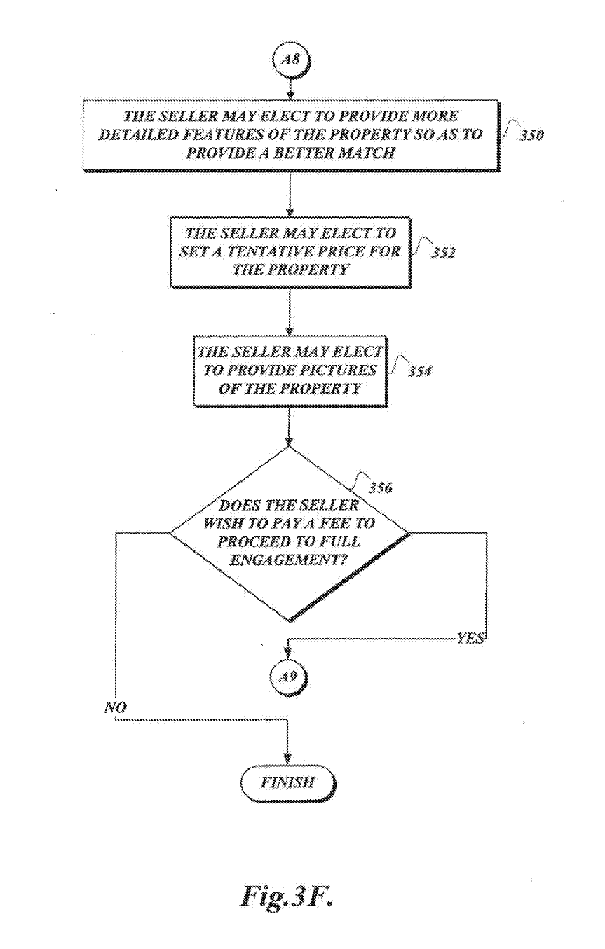

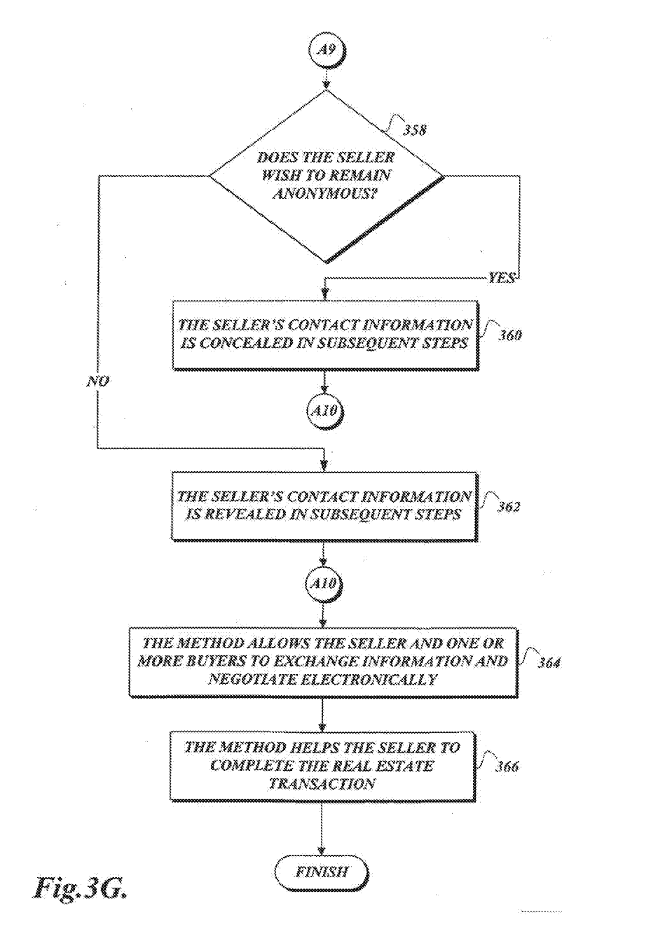

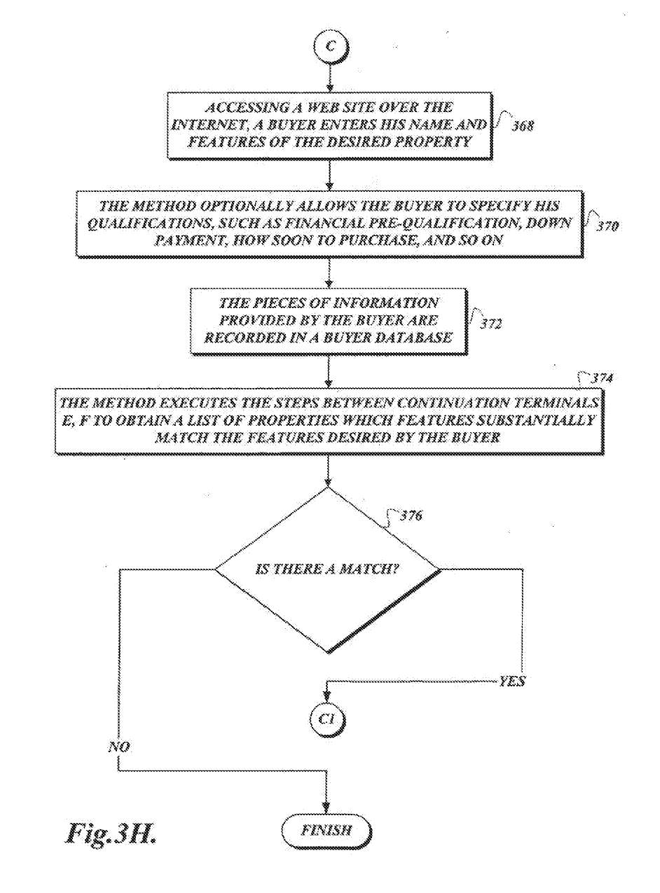

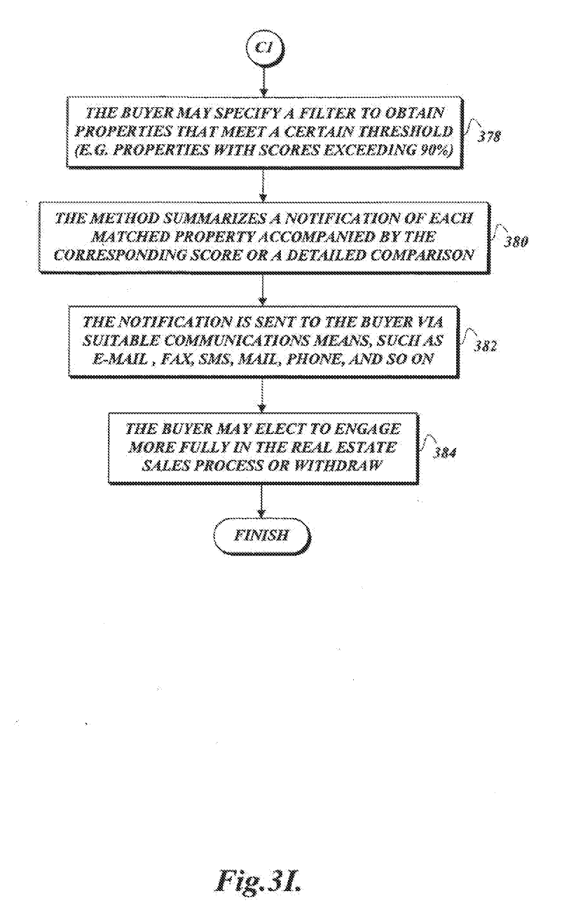

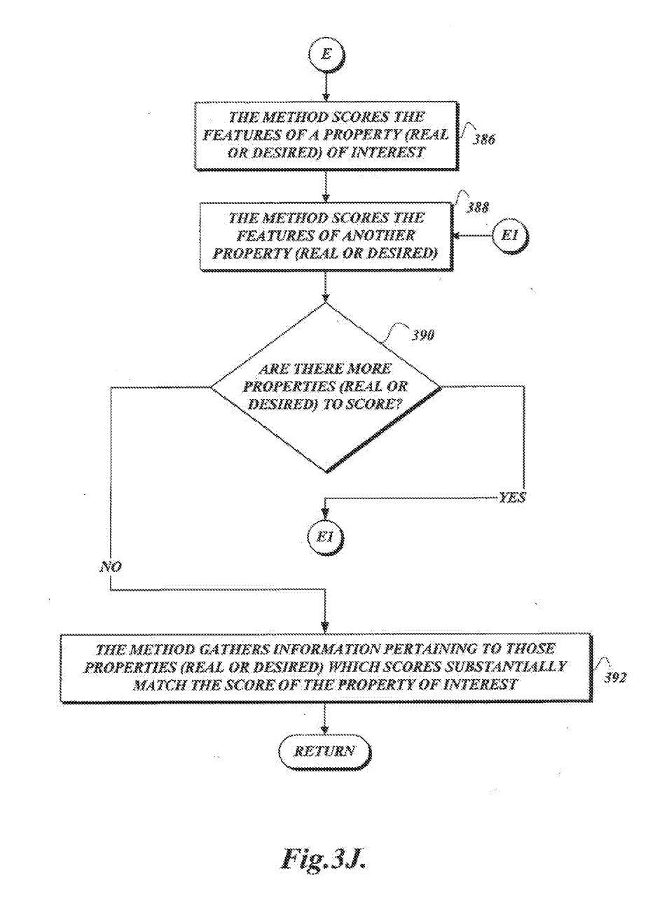

FIGS. 3A-3J illustrate a method 300 for facilitating a seller's on-line experience and a buyer's on-line experience using an exemplary method for matching real estate buyers to real estate sellers. From a start block, the method 300 proceeds to a set of method steps 302, defined between a continuation terminal (“terminal A”) and an exit terminal (“terminal B”). The set of method steps 302 describes that pieces of information are received from sellers and compiled into a real estate seller database. In one embodiment, the seller may have been enticed to provide information to the real estate seller database because of a notification received from the buyers who are registered members of the system 100. In another embodiment, the seller may enticed to provide information so as to receive a list of ranked buyers 108 without any notification. The method 300 also proceeds to a set of method steps 304 in parallel with proceeding to the set of method steps 302, defined between a continuation terminal (“terminal C”) and an exit terminal (“terminal D”). The set of method steps 304 describes that pieces of information are received from buyers and compiled into a real estate buyer database. Operating independently when invoked, the method 300 also proceeds to a set of method steps 306, defined between a continuation terminal (“terminal E”) and an exit terminal (“terminal F”). The set of method steps 306 describes an execution of a matching algorithm to match buyers and sellers of real estate.

From terminal A (FIG. 3B), the method 300 proceeds to block 308 where, accessing a Web site over the Internet, a seller enters his name and the address of his property. At block 310, the method accesses tax assessor records and matches the seller with tax assessor records at block 312. Data is extracted from the property records and presented to the seller for verification (e.g., the method shows how many bedrooms, baths, property size, and so on, and the seller is asked to verify the information). See block 314. At block 316, the seller is asked by the method to supplement the tax record information by filling in further data fields that are not found in the tax assessor records (e.g., the style of home, fireplaces, and so on). The method then automatically creates listing information from the verified data of the tax assessor records and the supplemental data from the seller. See block 318. The method 300 then proceeds, in parallel, to continuation terminals (“terminal A1” and “terminal A2”).

From terminal A1 (FIG. 3C), seller's information is entered into the system and then matched with buyer profile information from the buyer database and/or the data is then used to derive a comparative market analysis (CMA). In other words, using the extracted features and the supplemental features, the method at block 320 compares the seller's property to recent sales. At block 322, the method may also compare the seller's property to current listings and other sales trends. The seller is presented with a CMA, which could include an analysis of recently-sold properties, properties that are currently on the market, and general sales trends. See block 324. The method then terminates execution.

From terminal A2 (FIG. 3C), the method executes the steps between continuation terminals E-F to obtain a list of buyers whose property search features substantially match the features of the seller's property. See block 326. The method then proceeds to decision block 328, where a test is performed to determine whether the seller has subscribed to obtain buyers' identities. If the answer to the test at decision block 328 is no, the method proceeds to another continuation terminal (“terminal A4”). Otherwise, if the answer to the test at decision block 328 is yes, the method proceeds to another continuation terminal (“terminal A3”).

From terminal A3 (FIG. 3D), the method proceeds to block 330 where the method proceeds to review buyers' identities whose property search profiles are potential matches with the seller's property. The method then continues to another continuation terminal (“terminal A5”). From terminal A4 (FIG. 3D), the method proceeds to block 332 where the method conceals buyers' identities in subsequent steps. The method continues to terminal A5 (FIG. 3D), and proceeds to block 334 where the method provides to the seller a scoring of the extent of the match for various buyers (similar to a display that buyers receive regarding a subject property). At block 336, the method provides to the seller the number of buyers who are likely to be interested in the seller's property. The method also presents a list of buyers who are pre-qualified for financing. See block 338. At block 340, the method also presents a list of buyers who will not require financing. The method then continues to another continuation terminal (“terminal A6”).

From terminal A6 (FIG. 3E), the method also presents a list of buyers who have contingencies, such as the sale of another property. See block 342. The method may also present other factors that might make some buyers more attractive to the seller than others (not shown). Again, the buyers' contact information and identity may or may not be disclosed, depending upon the arrangement with an entity operating the system 100 of FIG. 1 and as previously tested at decision block 328. For example, if the business model is one in which the seller or potential sellers paid a subscription fee to the entity, this may entitle the sellers to the contact information. On the other hand, if there were no economic benefit to the entity derived from the seller (buyer), then contact information would be withheld until later in the process. At decision block 344, a test is performed to determine whether the seller wishes to engage one or more buyers based on the information provided so far. If the answer to the test at decision block 344 is yes, the method proceeds to another continuation terminal (“terminal A7”). Otherwise, if the answer to the test at decision block 344 is no, the method proceeds to block 346 where the seller decides whether to receive periodic updates of the list of potential buyers and the comparative market analysis. Optionally, the seller may opt out from the process entirely. The method then terminates execution. If the seller elects to engage further as tested at decision block 344, the method proceeds to block 348 from terminal A7 (FIG. 3E). There are several levels of engagement that the method offers and can be selected by the seller in the real estate sales process. The method 300 proceeds from block 348 to another continuation terminal (“terminal A8”).

From terminal A8 (FIG. 3F), the method proceeds to block 350 where the seller may elect to provide more detailed features of the property so as to provide a better match or such that the match could be scored more accurately. At block 352, the seller may elect to set a tentative price for the property. The seller may elect to provide pictures of the property. See block 354. In other embodiments, the seller may elect to engage with some or all of the prospective buyers, still without having committed to sell the property or, in some cases, even having identified the seller or the specific property address. At decision block 356, a test is performed to determine whether the seller wishes to pay a fee to proceed to full engagement. If the answer to the test at decision block 356 is yes, the method proceeds to another continuation terminal (“terminal A9”). Otherwise, if the answer to the test at decision block 356 is no, the method terminates execution. From terminal A9 (FIG. 3G), the method proceeds to decision block 358 where a test is performed to determine whether the seller wishes to remain anonymous. If the answer to the test at decision block 358 is yes, the method proceeds to block 360 where the seller's contact information is concealed in subsequent steps. The method then continues to another continuation terminal (“terminal A10”). If the answer to the test at decision block 358 is no, the method proceeds to block 362 where the seller's contact information is revealed in subsequent steps. The method then proceeds to terminal A10 and continues to block 364 where the method allows the seller and one or more buyers to exchange information and negotiate electronically. Depending upon the nature of the relationship between the seller and the entity operating the system 100, the seller could proceed with the transaction with no further help from the entity, or as indicated in block 366, with full “listing agent” type assistance, including listing with the MLS (in those instances where the entity is a member). In this case, the method helps the seller to complete the real estate transaction. The method 300 then terminates execution.

From terminal C (FIG. 3H), the method 300 proceeds to block 368 where, by accessing a Web site over the Internet, a buyer enters his name and the features of a desired property. The buyer fills out an on-line form describing the desired property (whose fields substantially correspond to the fields used by the sellers). Various embodiments of the present invention allow a potential buyer to fill out a profile describing the features of a property that would be of interest. In this case, however, once the profile is completed and submitted on-line, the buyer receives an estimate and analysis of what he might expect to pay for a home of that description. In the alternative, the potential buyer can submit a specific listing or property that is for sale or not for sale to a predictive piece of software executing on the discovery engine and it will return an estimate and analysis of the appropriate fair market value of the subject property.

The software that powers various embodiments of this invention is based on several potential templates for analysis and comparison of comparable properties. When the system receives the profile or the address of the specific property, it accesses (1) the tax assessor's database to identify comparable properties within a geographic area (which may be defined by the buyer); (2) databases (such as the MLS) of comparable properties currently for sale; and (3) databases of recent sales. It then applies one or more algorithms, taking into consideration several factors, such as sales history, the relationship of sales history to assessed values, the relationship of sale prices to listing prices, and relevant environmental factors, such as crime rates, school systems, and proximity to other positive or negative elements (e.g., noise from freeways, proximity to a waste transfer station, proximity to an airport and flight path, and so on). In this way, it will give a buyer an estimate of what an assessor might appraise the property for in the event of a purchase. In addition, the system will provide a confidence level or range of values with different confidence levels, based on a comparison of system estimates of fair market value already performed versus actual selling prices. The system can perform a fair market value estimate for any property (whether immediately requested by a buyer or not) and, by comparing these estimates with actual sales prices, refine the model to improve its accuracy based on actual results. As a result, a potential buyer would not only get a fair market value analysis, but also see that, in the past, the system has, for example, been accurate within a certain (e.g., 10%) range for this type of property a certain percentage of the time (e.g., 95%).

In addition to estimating fair market value, the software may automatically generate information about a given property that may not appear in the listing data. Again, by accessing databases and GPS data, the software can alert buyers to factors that they may want to consider before purchasing the property, such as estimated commute times to their work or an airport; proximity to half-way houses or group homes; crime statistics; proximity to a released sexual offender; or other desirable or undesirable factors within a specified radius.

Returning to FIG. 3H, at block 370, the method 300 optionally allows the buyer to specify his qualifications, such as financial pre-qualification, down payment, how soon to purchase, and so on. At block 372, the pieces of information provided by the buyer are recorded in a buyer database. The method 300 then executes the steps between continuation terminals E, F to obtain a list of properties which features substantially match the features desired by the buyer. See block 374. A test is performed at decision block 376 to determine whether there is a match. If the answer to the test at decision block 376 is yes, the method 300 proceeds to another continuation terminal (“terminal C1”). Otherwise, if the answer to the test at decision block 376 is no, the method terminates execution.

From terminal C1 (FIG. 3I), the buyer may specify a filter to obtain properties that meet a certain threshold (e.g., properties with scores exceeding a percentage, such as 90%). See block 378. In one embodiment, the filter is an electronic filter that can exclude all matches unless they meet certain thresholds set by the buyer. At block 380, the method summarizes a notification of each matched property accompanied by a corresponding score or a detailed comparison of the search versus the subject property. The notification is sent to the buyer via suitable communications means, such as e-mail, fax, SMS, mail, phone, and so on, depending upon the arrangement with the buyer.

The buyer can either affirm his continuing interest or withdraw from the process at any point during the information exchange process. See block 384. In one embodiment, the buyer explicitly reaches out to an owner (and potential seller) of a piece of property by notifying the owner of his interest in the piece of property. The notification can be transmitted using any suitable means, such as mail or e-mail. In the notification, the buyer may provide personal information that may entice the owner to sell the piece of property. For example, if a property looks interesting, the buyer may affirm his interest; but then, if the seller specifies a tentative price in a subsequent communication through the entity operating the system 100, buyer may withdraw or respond with his own price. Until such time (if ever) as the seller elects to engage directly with the buyer, the entity serves as the electronic intermediary, acting as an exchange or clearinghouse for messages between buyers and sellers. The method then terminates execution.

A set of method steps 306, as described before, defined between the terminal E and the exit terminal F, describes a matching algorithm that aligns potential buyers and sellers. From terminal E (FIG. 3J), the method 300 proceeds to block 386 where the method scores the features of a property (real or desired) of interest. At block 388, the method scores the features of another property (real or desired). A test is performed at decision block 390 to determine whether there are more properties (real or desired) to score. If the answer to the test at decision block 930 is yes, the method proceeds to a continuation terminal (“terminal E1”) and skips back to block 388 where the above-identified processing steps are repeated. Otherwise, if the answer to the test at decision block 390 is no, the method proceeds to block 392 where the method gathers information pertaining to those properties (real or desired) whose scores substantially match the score of the property of interest. The results may be presented in a form such as the user interface 200 of FIG. 2. The method 300 then returns to processing steps that invoked the set of method steps between terminals E, F.

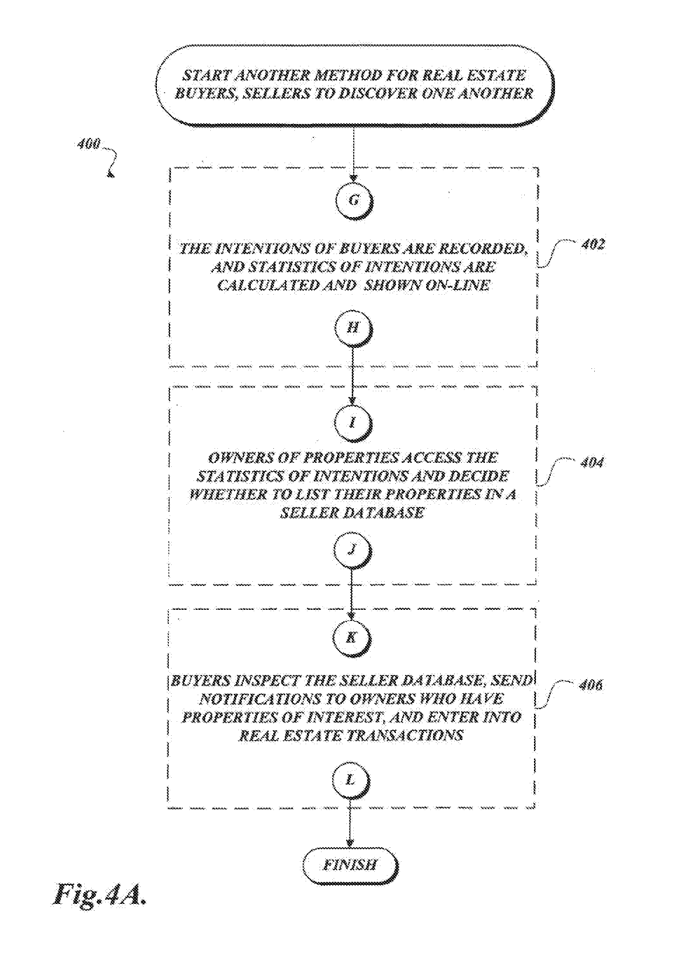

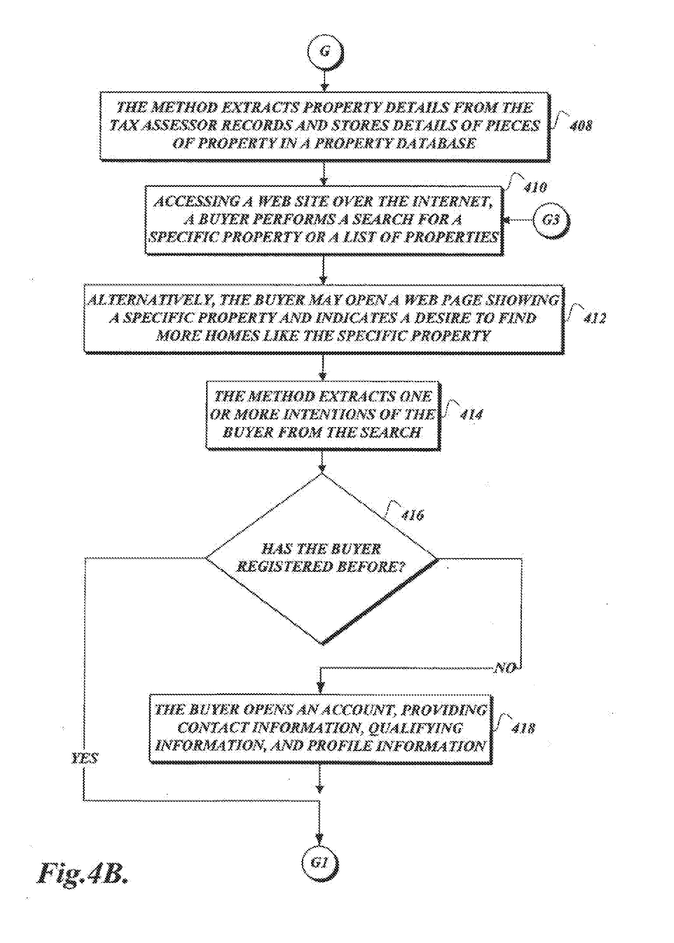

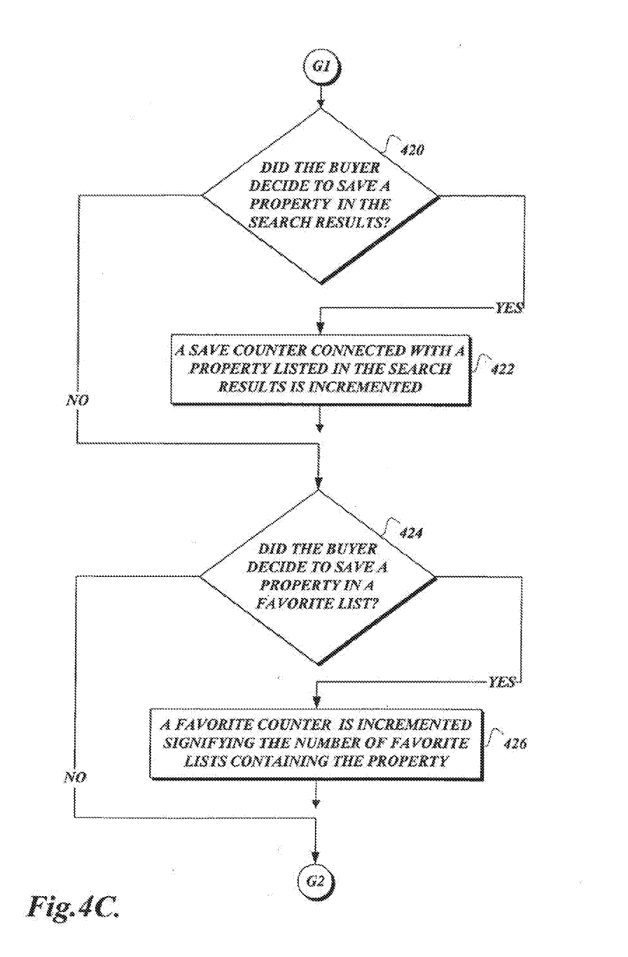

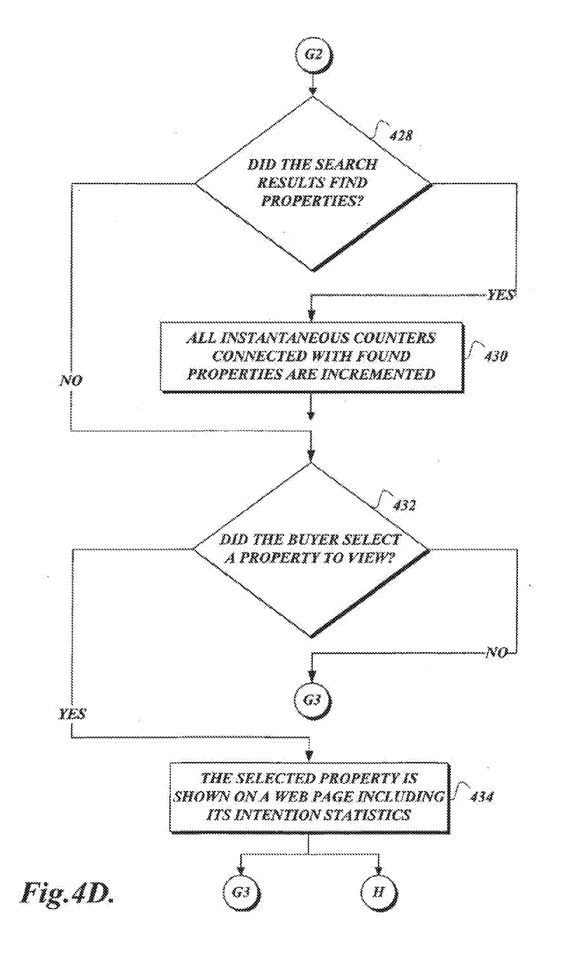

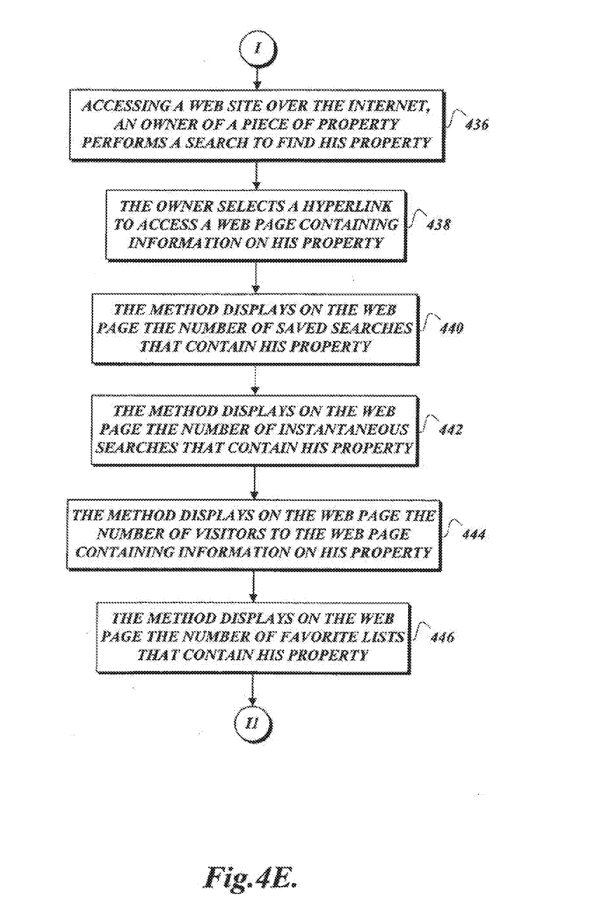

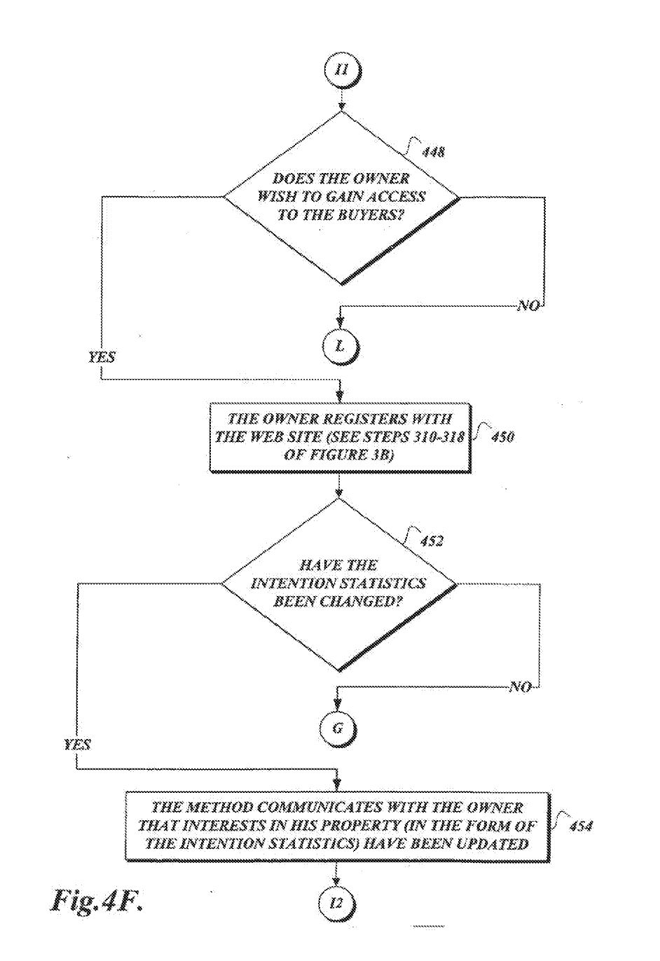

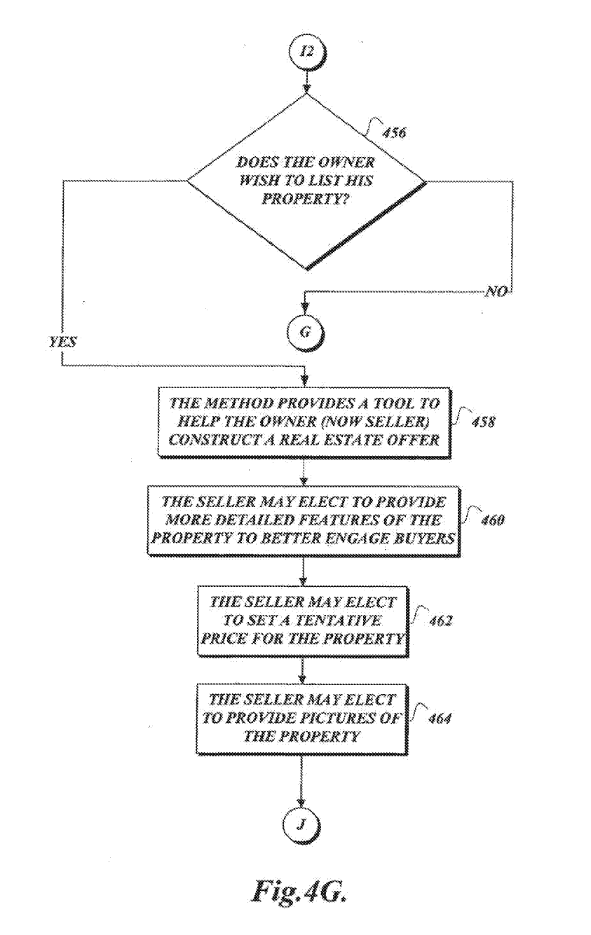

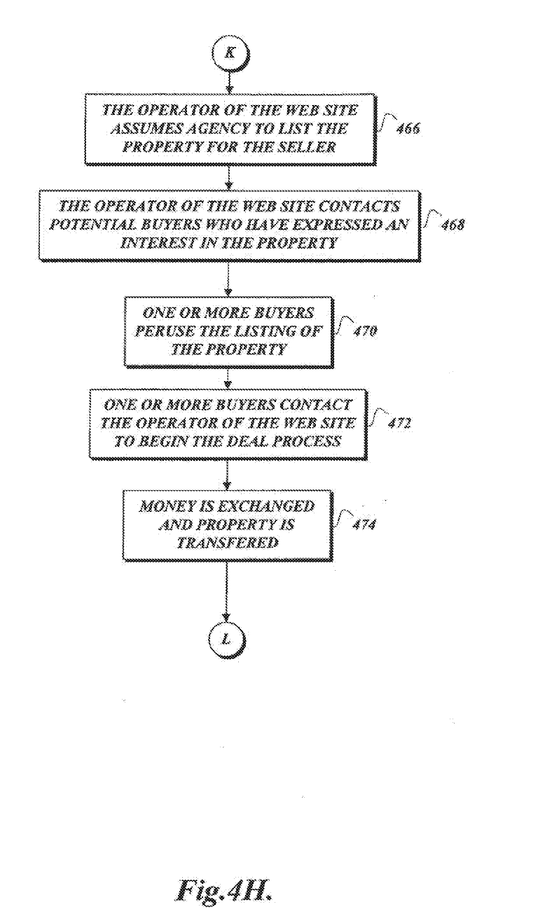

FIGS. 4A-4H illustrate a method 400 for allowing real estate buyers, sellers to discover one another. From a start block, the method 400 proceeds to a set of method steps 402 defined between a continuation terminal (“terminal G”) and an exit terminal (“terminal H”). The set of method steps 402 describes the recording of intentions of buyers and the calculation of statistics of intentions and are presented offline or on-line.

From terminal G (FIG. 4B), the method 400 proceeds to block 408 where the method extracts property details from the tax assessor records and stores details of properties in a property database. At block 410, accessing a Web site over the Internet, a buyer performs a search for a specific property or a list of properties. Alternatively, at block 412, the buyer may open a Web page showing a specific property and indicate a desire to find more homes like the specific property by clicking a hyperlink. At block 414, the method extracts one or more intention(s) from the buyer from the search. Such intentions can be gleaned by explicit parameters specified by the buyer or through the terms of a search query provided by the buyer. At decision block 416, a test is performed to determine whether the buyer has registered with the system 100 before. If the answer to the test at decision block 416 is no, the method proceeds to block 418 where the buyer opens an account, providing contact information, qualifying information, and optionally, profile information. For example, the buyer may describe that “we're a family with two children and a dog.” If the answer to the test at decision block 416 is yes, the method proceeds to another continuation terminal (“terminal G1”).

From terminal G1 (FIG. 4C), the method 400 proceeds to decision block 420 where a test is performed to determine whether the buyer decided to save a property in the search results. If the answer to the test at decision block 420 is yes, the method proceeds to block 422 where a save counter connected with a property listed in the search results is incremented. This is used later for calculating intention statistics. If the answer to the test at decision block 420 is no, the method proceeds to another decision block 424 where another test is performed to determine whether the buyer decided to save a property in a favorite list. If the answer is yes to the test at decision block 424, the method 400 proceeds to block 426 where a favorite counter is incremented, signifying the number of favorite lists containing the property. Again, this counter is used for calculating intention statistics to gauge the demand for a certain piece of property tracked by the system 100. If the answer to the test at decision block 424 is no, the method proceeds to another continuation terminal (“terminal G2”).

From terminal G2 (FIG. 4D), the method 400 proceeds to decision block 428 where a test is performed to determine whether the search results found properties that fall within the search query. If the answer to the test at decision block 428 is yes, the method proceeds to block 430 where all instantaneous counters connected with found properties are incremented. A portion of the intentions statistics is based upon the instantaneous counters. If the answer to the test at decision block 428 is no, the method 400 proceeds to decision block 432 where a test is performed to determine whether the buyer selected a property to view. If the answer to the test at decision block 432 is no, the method continues to another continuation terminal (“terminal G3”). If the answer to the test at decision block 432 is yes, the method proceeds to block 434 where the selected property is shown on a Web page, including the property's intention statistics. The method 400 then proceeds, in parallel, to terminal G3 and exit terminal H. From terminal G3 (FIG. 4B), the method 400 skips to block 410 where the above-identified processing steps are repeated.

From terminal H (FIG. 4A), the method 400 proceeds to a set of method steps 404, defined between a continuation terminal (“terminal I”) and an exit terminal (“terminal J”). The set of method steps 404 describes that the owners of properties access the statistics of intentions and decide whether to list their properties in a real estate seller database.

From terminal I (FIG. 4E), accessing a Web site over the Internet, an owner of a piece of property performs a search to find his property. See block 436. The owner selects a hyperlink to access a Web page containing information on his property. See block 438. At block 440, the method displays on the Web page various intention statistics, such as the number of saved searches that contain his property. At block 442, the method also displays on the Web page the number of instantaneous searches that contain his property. The method then displays on the Web page the number of visitors to the property's Web page. See block 444. Next, at block 446, the method displays on the Web page the number of favorite lists that contain his property. The method then continues to another continuation terminal (“terminal 11”).

From terminal 11 (FIG. 4F), the method 400 proceeds to decision block 448 where a test is performed to determine whether the owner wishes to gain access to buyers. If the answer to the test at decision block 448 is no, the method continues to another continuation terminal (“terminal L”). Otherwise, if the answer to the test at decision block 448 is yes, the method proceeds to block 450 where the owner registers with the Web site (see steps 308-318 of FIG. 3B). The method then proceeds to another decision block 452 where another test is performed to determine whether the intention statistics have been changed. If the answer to the test at decision block 452 is no, the method proceeds to terminal G and skips back to block 408 where the above-identified processing steps are repeated. Otherwise, if the answer to the test at decision block 452 is yes, the method proceeds to block 454 where the method communicates with the owner that the intention statistics connected with the property have been updated. The method then proceeds to another continuation terminal (“terminal 12”).

From terminal 12 (FIG. 4G), the method proceeds to decision block 456 where a test is performed to determine whether the owner wishes to list his property. If the answer to the test at decision block 456 is no, the method proceeds to terminal G and skips back to block 408 where the above-identified processing steps are repeated. Otherwise, if the answer to the test at decision block 456 is yes, the method proceeds to block 458 where the method 400 provides a tool to help the owner (now seller) construct a real estate offer. The seller may elect to provide more detailed features of the property to better engage buyers. See block 460. The seller may elect to set a tentative price for the property. See block 462. At block 464, the seller may elect to provide pictures of the property. The method then continues to exit terminal J. From terminal J (FIG. 4A), the method continues to a set of method steps 406, defined between a continuation terminal (“terminal K”) and exit terminal L. The set of method steps 406 describes that the buyers inspect the seller database to choose properties to enter into a real estate transaction.

From terminal K (FIG. 4H), the operator of the Web site of the system 100 assumes agency power to list the property for the seller. See block 466. At block 468, the operator of the Web site contacts potential buyers who have expressed an interest in the property. To provide a brief summary at this point, using the intentions of buyers, owners may decide to become sellers by researching a market and proceed to create a private market by allowing the system 100 to contact or give notifications to the buyers who form a portion of the market the owners researched. The word “private market” means a market with specific admission criteria. Returning to FIG. 4H, the method proceeds to block 470 where one or more buyers peruse the listing of the property. At block 472, one or more buyers contacts the operator of the Web site to begin the real estate deal process. At block 474, money is exchanged and property is transferred. The method then continues to exit terminal L and terminates execution.

While illustrative embodiments have been illustrated and described, it will be appreciated that various changes can be made therein without departing from the spirit and scope of the invention.

1. At least one computer-readable medium including instructions that, when executed by at least one processing device, enables the at least one processing device to perform a method, the method comprising the steps of:
receiving an indication of an unlisted piece of real property from a seller user authorized to sell the unlisted piece of real property;
receiving from the seller user a proposed sale price for the unlisted piece of real property;
providing at least one graphical location-based search interface that enables a reviewer user to locate the unlisted piece of real, wherein the at least one interface provides to at least one electronic display device an interactive map of a geographic region that includes the unlisted piece of real property, the interactive map being manipulable by the reviewer user with an electronic input device coupled to the at least one electronic display device; and
after the reviewer user locates the unlisted piece of real property and before the unlisted piece of real property is listed, displaying the proposed sale price to the reviewer user.

2. The method of claim 1, wherein the at least one location-based search interface includes satellite imagery of the geographic region.

3. The method of claim 1, wherein the at least one interface is configured to allow the reviewer user to zoom the map.

4. The method of claim 1, wherein the at least one interface includes a selectable link to additional information descriptive of the piece of real property.

5. The method of claim 1, wherein the identity of the seller user is not exposed to the reviewer user.

6. A system comprising:
at least one processor; and
at least one storage device in communication with the at least one processor, the at least one storage device including instructions that, when executed by the at least one processor, enable the performance of a method comprising the steps of:
receiving an indication of an unlisted piece of real property from a seller user authorized to sell the unlisted piece of real property;
receiving from the seller user a proposed price at which the seller user may agree to sell the unlisted piece of real property;
providing at least one graphical location-based search interface that enables a reviewer user to select a geographic region that includes the unlisted piece of real property, wherein the at least one interface provides to at least one electronic display device a map of the geographic region, the map being manipulable by the reviewer user with an electronic input device coupled to the at least one electronic display device; and
after the reviewer user selects the geographic region and before the unlisted piece of real property is listed, exposing information describing the unlisted piece of real property and the proposed price to the reviewer user.

7. The method of claim 6, wherein the at least one location-based search interface includes satellite imagery of the geographic region.

8. The method of claim 6, wherein the at least one interface is configured to allow the reviewer user to zoom the map.

9. The method of claim 6, wherein the identity of the seller user is not exposed to the reviewer user.

10. The method of claim 6, wherein the at least one interface includes a selectable link to additional information descriptive of the piece of real property.

11. A system comprising:
at least one processor; and
at least one storage device in communication with the at least one processor, the at least one storage device including instructions that, when executed by the at least one processor, enable the performance of a method comprising the steps of:
receiving an indication from a seller user that the seller user is authorized to sell an unlisted parcel of real property;
receiving from the seller user a proposed sale price for the unlisted parcel of real property;
providing at least one graphical location-based search interface that enables a buyer user to locate the unlisted parcel of real property, wherein the at least one interface provides to at least one electronic display device an interactive map of a geographic region that includes the unlisted parcel of real property, the interactive map being manipulable by the reviewer user with an electronic input device coupled to the at least one electronic display device; and
after the buyer user locates the unlisted parcel of real property and before the unlisted parcel of real property is listed, displaying the proposed sale price to the buyer user.

12. The method of claim 11, wherein the at least one location-based search interface includes satellite imagery of the geographic region.

13. The method of claim 11, wherein the at least one interface is configured to allow the reviewer user to zoom the map.

14. The method of claim 11, wherein the identity of the seller user is not exposed to the reviewer user.

15. The method of claim 11, wherein the at least one interface includes a selectable link to additional information descriptive of the piece of real property.
